(19) United States
(12) Patent Application Publication
(10) Pub. No.: US 2023/0266439 A1
(43) Pub. Date: Aug. 24, 2023

(54) LIDAR SENSOR AND TARGET DETECTION METHOD USING THE SAME

(71) Applicant: HL KLEMOVE CORP., Incheon (KR)

(72) Inventor: Hyuk RYU, Seoul (KR)

(21) Appl. No.: 18/112,522

(22) Filed: Feb. 22, 2023

(30) Foreign Application Priority Data
Feb. 23, 2022 (KR) 10-2022-0023620

(51) Int. Cl. G01S 7/48; G01S 7/4911; G01S 7/484

(52) U.S. Cl. CPC G01S 7/4802; G01S 7/4911; G01S 7/484

(57) ABSTRACT

The present disclosure relates to a lidar sensor, comprising: a first transmitter configured to output laser light having a first output in an odd numbered frame, and to output laser light having a second output which is a lower output than the first output in an even numbered frame; a second transmitter configured to output laser light having the second output in an odd numbered frame, and to output laser light having the first output in an even numbered frame; and a receiver configured to receive reflected light of the laser light output from the first transmitter and the second transmitter to detect a target.

### CROSS-REFERENCE TO RELATED APPLICATION

This application claims priority to and the benefit of Korean Patent Application No. 10-2022-0023620, filed on Feb. 23, 2022, the disclosure of which is incorporated herein by reference in its entirety.

### TECHNICAL FIELD

The present disclosure relates to a lidar sensor and a target detection method using the same, and more particularly, to a lidar sensor capable of high-speed repetitive transmission while reducing heat generation, and a target detection method using the same.

### BACKGROUND

A lidar sensor for a vehicle is a sensor that outputs light to an object and measures the distance between the vehicle and the object based on a reflected signal.

The lidar sensor includes a transmitting end for outputting a laser light and a receiving end for receiving a laser light reflected from a target. In order to detect a long-distance or low-reflectivity target, a high output laser must be used.

As for the output of the laser, light is output from the internal laser module, and generally, the output power is determined according to the voltage applied to the laser module, but the output power cannot be increased indefinitely due to Eye-Safety standard restrictions.

The repetition rate in Hz is taken into account for the factor of the laser transmission together with the output power. The repetition rate represents the output cycle of the laser.

Conventionally, a lidar sensor uses a single array transmitting end, and when a single array transmitting end is used, an increase in the repetition rate causes a temperature increase of the transmitting end, and the output decreases according to the temperature increase, and it becomes a cause of a failure.

In addition, in the case of a lidar sensor for transmitting a constant output power, there is a limitation in a dynamic range for detecting a reflectivity of a target. That is, when a high output laser is transmitted to detect a long-distance or low-reflectivity target, a saturation phenomenon occurs at the receiving end when detecting a short-distance or high-reflectivity target.

In addition, in the case of a lidar sensor that transmits laser light at a constant repetition rate, it may be interfered with by transmission light from other lidar sensors. When the transmission light of the other lidar sensor is received, a saturation phenomenon of the receiving end may occur, and there was a problem that the target could not be detected for a certain period of time.

Therefore, there is a need for a lidar sensor that minimizes temperature rise while transmitting at a high repetition rate, secures a dynamic range of the receiving end, and does not cause interference with other lidar sensors.

### SUMMARY

### Technical Problem

The present disclosure is directed to providing a lidar sensor capable of minimizing a temperature increase while transmitting laser light at a high repetition rate.

Also, the present disclosure is directed to providing a lidar sensor capable of preventing interference with other lidar sensors in the vicinity.

### Technical Solution

According to an aspect of the present disclosure, there is provided a lidar sensor, including: a first transmitter configured to output laser light having a first output in an odd numbered frame, and to output laser light having a second output which is a lower output than the first output in an even numbered frame; a second transmitter configured to output laser light having the second output in an odd numbered frame, and to output laser light having the first output in an even numbered frame; and a receiver configured to receive reflected light of the laser light output from the first transmitter and the second transmitter to detect a target.

In an embodiment of the present disclosure, in the odd numbered frame, the laser light having the first output of the first transmitter may precede the laser light having the second output of the second transmitter.

In an embodiment of the present disclosure, the first output laser light of the first transmitter and the second output laser light of the second transmitter may be output with a certain time difference.

In an embodiment of the present disclosure, in the even numbered frame, the laser light having the second output of the first transmitter may lag behind the laser light having the first output of the second transmitter.

In an embodiment of the present disclosure, the first output laser light of the first transmitter and the second output laser light of the second transmitter may be output with a certain time difference.

In an embodiment of the present disclosure, the reflected light of the laser light of the first transmitter and the reflected light of the laser light of the second transmitter received by the receiver may be received at a certain interval and thus may be distinguished from laser lights transmitted from other lidar sensors.

A target detection method according to another aspect of the present disclosure may include a) by a first transmitter, outputting laser light having a first output in an odd numbered frame, and outputting laser light having a second output which is a lower output than the first output in an even numbered frame; b) by a second transmitter, outputting laser light having the second output in an odd numbered frame, and outputting laser light having the first output in an even numbered frame; and c) by a receiver, receiving reflected light of the laser light output from the first transmitter and the second transmitter to detect a target.

In an embodiment of the present disclosure, in the odd numbered frame, the laser light having the first output of the first transmitter may precede the laser light having the second output of the second transmitter.

In an embodiment of the present disclosure, the first output laser light of the first transmitter and the second output laser light of the second transmitter may be output with a certain time difference.

In an embodiment of the present disclosure, in the even numbered frame, the laser light having the second output of the first transmitter may lag behind the laser light having the first output of the second transmitter.

In an embodiment of the present disclosure, the first output laser light of the first transmitter and the second output laser light of the second transmitter may be output with a certain time difference.

In an embodiment of the present disclosure, the reflected light of the laser light of the first transmitter and the reflected light of the laser light of the second transmitter received by the receiver may be received at a certain interval and thus may be distinguished from laser lights transmitted from other lidar sensors.

### Advantageous Effects

The present disclosure includes two arrays of transmitting ends and minimizes heat generation by alternately differentiating the output of each transmitting end for each frame, thereby capable of detecting a low-reflectivity target with high resolution by increasing the repetition rate, and capable of preventing saturation of the receiving end.

In addition, according to the present disclosure, by alternately differentiating the output of each transmitting end, it is possible to prevent saturation of the receiving end, increase a detection distance, and obtain target reflectivity information below a reference distance.

In addition, the present disclosure can prevent interference with other lidar sensors in the vicinity by controlling the output and repetition rate of each of the two arrays of transmitting ends.

### BRIEF DESCRIPTION OF THE DRAWINGS

FIGS. 1 and 2 are exemplary diagrams illustrating a configuration of a lidar sensor according to a preferred embodiment of the present disclosure.

FIG. 3 is a transmission output graph of output laser light of a first transmitter and a second transmitter.

FIG. 4 is an exemplary diagram of a received signal for a high-reflectivity target in an odd numbered frame of the present disclosure.

FIG. 5 is an exemplary diagram of a received signal for a low-reflectivity target in an odd numbered frame.

FIG. 6 is a waveform diagram for explaining that the lidar sensor of the present disclosure can prevent interference with a conventional lidar sensor.

FIG. 7 is a graph of an output of a first transmitter and an output of a second transmitter for each frame.

FIG. 8 is a comparative graph of a laser temperature change of the present disclosure and the conventional lidar sensor.

### DETAILED DESCRIPTION OF THE EMBODIMENTS

Hereinafter, a lidar sensor and a target detection method using the same of the present disclosure will be described in detail with reference to the accompanying drawings.

Embodiments of the present disclosure are provided to describe the present disclosure more fully to those skilled in the art, the embodiments described below can be modified into various other forms, and the scope of the present disclosure is not limited to the following embodiments. Rather, these embodiments make the present disclosure more meaningful and complete and are provided for fully conveying the concept of the present disclosure to those skilled in the art.

The terms used in this specification are for the purpose of describing particular embodiments only and are not intended to limit the present disclosure. As used herein, the singular forms are intended to include the plural forms as well, unless the context clearly indicates otherwise. In addition, the terms “comprise” and/or “comprising,” when used in this specification, specify the presence of stated shapes, integers, steps, operations, members, elements, and/or a group thereof but do not preclude the presence or addition of one or more other shapes, integers, steps, operations, members, elements, and/or groups thereof. As used herein, the term “and/or” includes any one of and all combinations of one or more of the relevant listed items.

Although the terms “first,” “second,” etc. are used herein to describe various members, regions, and/or parts, it is apparent that these members, components, regions, layers, and/or parts are not limited by these terms. These terms do not imply any particular order, top, bottom, or superiority and are used only to distinguish one member, region, or part from another member, region, or part. Thus, the first member, the first region, or the first part described below may refer to the second member, the second region, or the second part without departing from the teachings of the present disclosure.

Hereinafter, the embodiments of the present disclosure are described with reference to the drawings schematically illustrating the embodiments of the present disclosure. In the drawings, for example, variations in the illustrated shape may be expected depending on manufacturing techniques and/or tolerances. Accordingly, the embodiments of the present disclosure should not be construed as being limited to any particular shape of the regions illustrated herein and should include, for example, variations in shape resulting from manufacturing.

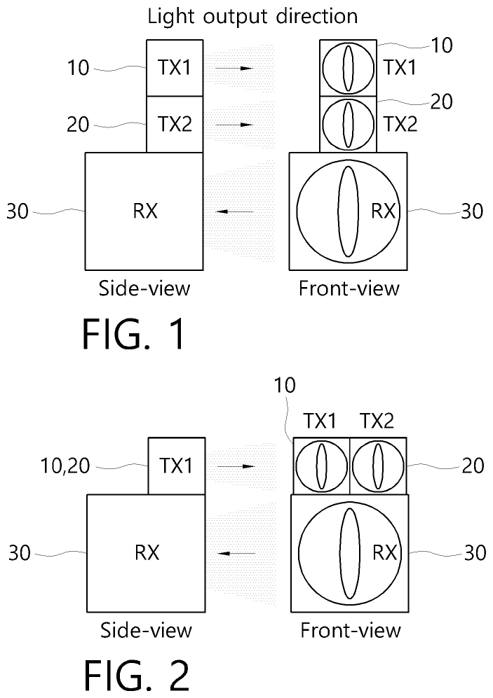

FIGS. 1 and 2 are diagrams respectively illustrating the arrangement state of the lidar sensor according to a preferred embodiment of the present disclosure.

Referring to FIGS. 1 and 2, the present disclosure includes a first transmitter 10, a second transmitter 20 and a receiver 30.

FIG. 1 illustrates an example in which the first transmitter 10 and the second transmitter 20 are arranged up and down on one surface of the receiver 30, respectively, and FIG. 2 illustrates an example in which the first transmitter 10 and the second transmitter 20 are arranged left and right on one surface of the receiver.

The first transmitter 10 and the second transmitter 20 include at least a laser output module for outputting laser light, and a lens, and the receiver 30 includes at least a lens and a light receiving sensor for receiving laser light.

The present disclosure may be applied to a structure that scans while reflecting the output laser light of the first transmitter 10 and the second transmitter 20 to a certain area by applying a scanner. The scanner may also serve to render the laser reflected light reflected from the target to enter the receiver 30.

The present disclosure may also be applied to a structure that does not use a scanner. A feature of the present disclosure is to differentiate the output and repetition rate of the laser light of the first transmitter 10 and the second transmitter 20, and particularly, the transmission output of the laser light is alternately output at a large and small power.

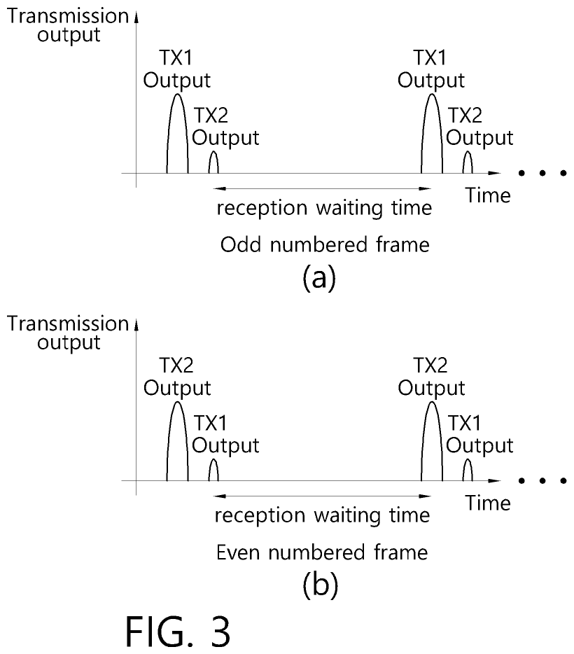

FIG. 3 illustrates a transmission output graph of the output laser light of the first transmitter 10 and the second transmitter 20.

FIG. 3(a) is an odd numbered frame, and FIG. 3(b) illustrates a transmission output in an even numbered frame.

That is, the lidar sensor of the present disclosure alternately outputs the output shown in FIG. 3(a) and the output shown in FIG. 3(b).

First, in the odd numbered frame, the output Tx1 of the first transmitter 10 is output to have a greater output than the output Tx2 of the second transmitter 20.

The laser light of the relatively large output Tx1 of the first transmitter 10 is output, and then the laser light of the relatively small output Tx2 of the second transmitter 20 is output, and they are repeatedly output at a certain repetition rate in consideration of the reception signal waiting time for determining the detection distance.

That is, the laser light outputs Tx1 and Tx2 of the first transmitter 10 and the second transmitter 20 are output with a time difference.

In the even numbered frame, the output Tx2 of the second transmitter 20 is output so as to have a larger transmission output than the output Tx1 of the first transmitter 10, and the output order of the second transmitter 20 is controlled so that the output Tx2 is faster than the output Tx1 of the first transmitter 10.

Although not shown in the drawings, this control may be performed by a controller controlling the output of the first transmitter 10 and the second transmitter 20.

By this control, the output of the first transmitter 10 may be increased in an odd numbered frame, and the output of the first transmitter 10 may be decreased in an even numbered frame, thereby preventing a relatively high transmission output state from being continuously maintained, thereby reducing an increase in temperature.

This applies to the second transmitter 20.

The lidar sensor obtains reflectivity information of a target based on the intensity of a received signal received in the receiver 30, and if a signal having a certain intensity or more is received according to a maximum voltage setting of the receiver 30, it is saturated and reflectivity information cannot be obtained.

However, in the present disclosure, since two laser lights of the first transmitter 10 and the second transmitter 20 having a relatively strong output and a relatively weak output are output in the same frame, and the laser lights are received in the receiver 30, a decrease in the maximum detection distance can be prevented while preventing saturation.

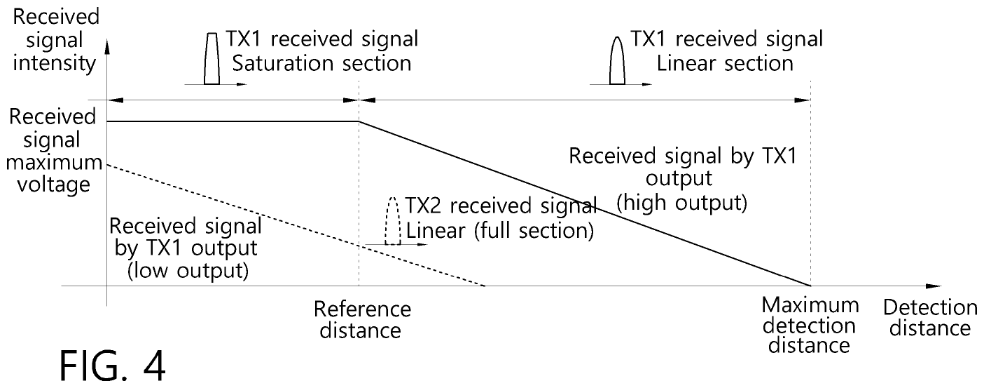

FIG. 4 is an exemplary diagram of a received signal for a high-reflectivity target in an odd numbered frame of the present disclosure.

Referring to FIG. 4, the first transmitter 10 output Tx1 having the relatively strong transmission output in the odd numbered frame may become a saturation state without a change in a received signal according to a distance within a reference distance, but reflected light of the first transmitter 10 output Tx1 may be linearly reduced above the reference distance, thereby detecting a high-reflectivity target to a maximum detection distance.

Further, within the reference distance from the lidar sensor, the reflected light of the second transmitter 20 output Tx2 having a relatively low transmission output represents a linearly decreasing waveform without a saturation section, and thus the reflectivity information of the target may be obtained.

In the even numbered frame, on the contrary, the maximum detection distance is determined by the output Tx2 of the second transmitter 20, and target detection within the reference distance is performed by the reflected light of the output Tx1 of the first transmitter 10 having a relatively low transmission output.

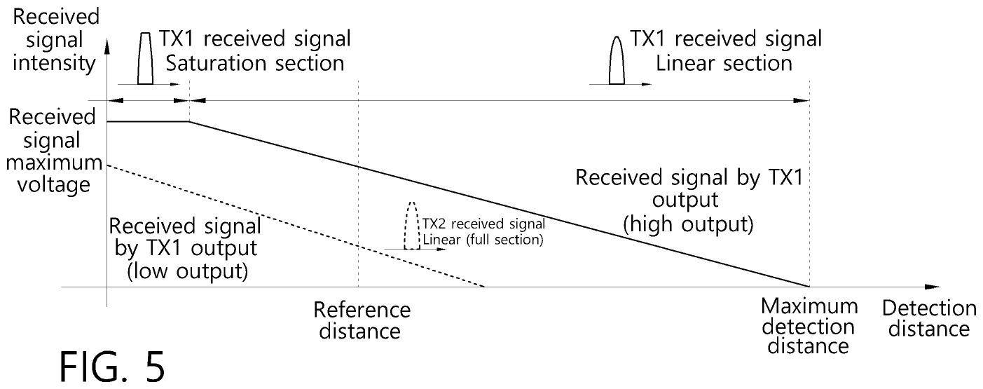

FIG. 5 is an exemplary diagram of a received signal for a low-reflectivity target in an odd numbered frame.

Referring to FIG. 5, although the maximum detection distance decreases compared to the waveform illustrated and described in FIG. 4, and the distance of the saturation section decreases, the target may be detected by the reflected light of the output Tx2 of the second transmitter 20 in the saturation section of the first transmitter 10.

As described above, the present disclosure may transmit the transmitted laser light having different output intensities and prevent the receiver 30 from being saturated, thereby improving a dynamic range for a lidar sensor to detect a reflectivity of a target.

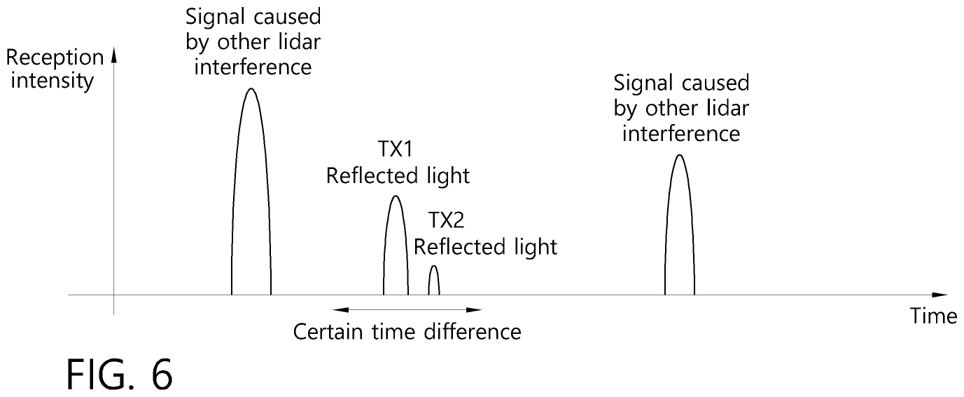

FIG. 6 is a waveform diagram for explaining that the lidar sensor of the present disclosure can prevent interference with a conventional lidar sensor.

Referring to FIG. 6, the present disclosure receives reflected light having different sizes by two transmission outputs Tx1 and Tx2 having a certain time difference, and a signal received by the receiver 30 may generate a signal at an arbitrary position regardless of a target due to interference of a conventional lidar sensor, and may be received as a signal that is greater or less than reflected light by the first transmitter output Tx1 or reflected light by the second transmitter 20 output Tx2 depending on the position of the lidar generating an interference signal.

In addition, in the present disclosure, since the reflected light of the two transmission outputs Tx1 and Tx2 output with a certain time difference is received by the receiver 30, the interference signal of the other lidar sensor and the received signal of the transmission outputs Tx1 and Tx2 may be distinguished using a size and an interval of a signal received by the receiver 30.

According to such distinguishing, excluding the interference signal, an accurate distance to a target may be determined.

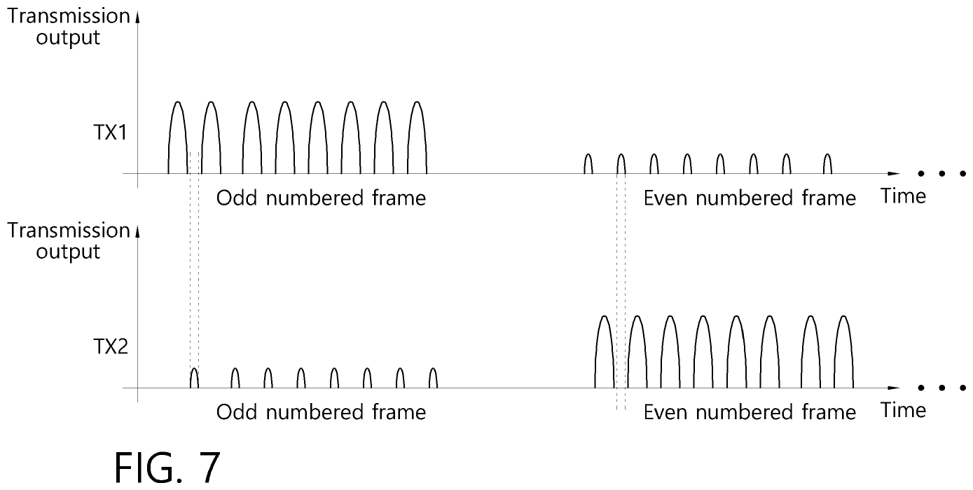

FIG. 7 is a graph of the output Tx1 of the first transmitter 10 and the output Tx2 of the second transmitter 20 for each frame described above.

As illustrated in this way, in the present disclosure, the output Tx1 of the first transmitter 10 repeats a relatively high output and low output section for each frame, and on the contrary, the output Tx2 of the second transmitter 20 repeats a relatively low output and high output section for each frame, thereby making the temperature of the laser, which is the transmission element of the first transmitter 10 and the second transmitter 20, repeatedly increase and decrease, thereby minimizing the increase in the temperature of the laser.

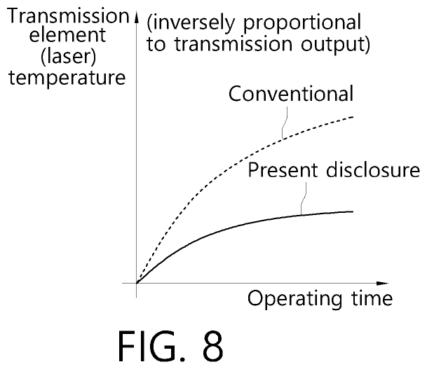

As can be seen from the laser temperature change graph of FIG. 8, the lidar sensor of the present disclosure may maintain a lower temperature compared to a transmitting end temperature of a conventional lidar sensor.

Therefore, it is possible to minimize the decrease in transmission output due to heat generation of the lidar sensor transmitting end, and to prevent failure or damage caused by heat generation.

It will be apparent to those skilled in the art to which the present disclosure belongs that the present disclosure is not limited to the above-described embodiments and may be variously modified and changed within a range which does not depart from the technical gist of the present disclosure.

<Description of Symbols>
10: first transmitter
20: second transmitter
30: receiver

1. A lidar sensor, comprising:
a first transmitter configured to output laser light having a first output in an odd numbered frame, and to output laser light having a second output which is a lower output than the first output in an even numbered frame;
a second transmitter configured to output laser light having the second output in an odd numbered frame, and to output laser light having the first output in an even numbered frame; and
a receiver configured to receive reflected light of the laser light output from the first transmitter and the second transmitter to detect a target.

2. The lidar sensor of claim 1, wherein in the odd numbered frame, the laser light having the first output of the first transmitter precedes the laser light having the second output of the second transmitter.

3. The lidar sensor of claim 2, wherein the first output laser light of the first transmitter and the second output laser light of the second transmitter are output with a certain time difference.

4. The lidar sensor of claim 1, wherein in the even numbered frame, the laser light having the second output of the first transmitter lags behind the laser light having the first output of the second transmitter.

5. The lidar sensor of claim 4, wherein the first output laser light of the first transmitter and the second output laser light of the second transmitter are output with a certain time difference.

6. The lidar sensor of claim 1, wherein the reflected light of the laser light of the first transmitter and the reflected light of the laser light of the second transmitter received by the receiver are received at a certain interval and thus are distinguished from laser lights transmitted from other lidar sensors.

7. A target detection method using a lidar sensor, comprising:
a) by a first transmitter, outputting laser light having a first output in an odd numbered frame, and outputting laser light having a second output which is a lower output than the first output in an even numbered frame;
b) by a second transmitter, outputting laser light having the second output in an odd numbered frame, and outputting laser light having the first output in an even numbered frame; and
c) by a receiver, receiving reflected light of the laser light output from the first transmitter and the second transmitter to detect a target.

8. The target detection method using a lidar sensor of claim 7, wherein in the odd numbered frame, the laser light having the first output of the first transmitter precedes the laser light having the second output of the second transmitter.

9. The target detection method using a lidar sensor of claim 8, wherein the first output laser light of the first transmitter and the second output laser light of the second transmitter are output with a certain time difference.

10. The target detection method using a lidar sensor of claim 7, wherein in the even numbered frame, the laser light having the second output of the first transmitter lags behind the laser light having the first output of the second transmitter.

11. The target detection method using a lidar sensor of claim 10, wherein the first output laser light of the first transmitter and the second output laser light of the second transmitter are output with a certain time difference.

12. The target detection method using a lidar sensor of claim 7, wherein the reflected light of the laser light of the first transmitter and the reflected light of the laser light of the second transmitter received by the receiver are received at a certain interval and thus are distinguished from laser lights transmitted from other lidar sensors.

13. A lidar sensor comprising a plurality of transmitters and one receiver,
wherein at least one first transmitter of the plurality of transmitters periodically alternately outputs a laser light having a first output and a laser light having a second output lower than the first output, and another second transmitter of the plurality of transmitters periodically alternately outputs a laser light having a second output and a laser light having a first output, so that a result of receiving the laser lights of the transmitters received by the receiver is distinguished from laser lights transmitted from other lidar sensors.

14. The lidar sensor of claim 13, wherein a timing of transmitting the laser light of the first transmitter and the second transmitter is different from each other.

15. The lidar sensor of claim 14, wherein the laser light of the first transmitter and the laser light of the second transmitter are output with a certain time difference.

16. The lidar sensor of claim 15, wherein the first transmitter and the second transmitter control an output timing so that the laser light of the first output precedes and the laser light of the second output lags behind.
